(19) United States
(12) Patent Application Publication
(10) Pub. No.: US 2014/0098644 A1
(43) Pub. Date: Apr. 10, 2014

(54) Chirp to control devices

(71) Applicant: Wesley John Boudville, Pasadena, CA (US)

(72) Inventor: Wesley John Boudville, Pasadena, CA (US)

(21) Appl. No.: 13/573,823

(22) Filed: Oct. 9, 2012

(51) Int. Cl. G08B 3/10

(52) U.S. Cl. CPC G08B 3/10
USPC 367/197

(57) ABSTRACT

A screen emits a chirp. A mobile device decodes the chirp to control the screen. A screen has several speakers emitting different chirps. The decoding by a mobile device allocates a split screen to the device, that is closest to it. A screen has a microphone that decodes a chirp from a device, letting the device control the screen. A blacklist is applied by a mobile device to a chirp. The blacklist can be a function of the date and location of the device. The querying of an audio server by a mobile device to decode a chirp can be minimised, for faster decoding. The header has bits pointing to a key in a table in the audio server. The value is an URL prefix, for a company with devices emitting chirps. The prefix is cached by a mobile device. Subsequent chirps with the same key let the device use the cached prefix instead of calling the audio server. A device connected to the Internet runs a web server. The device lacks a screen. It emits a chirp wrapping an URL. A mobile device decodes the chirp and gets pages to control the device or show data from the device.

### TECHNICAL FIELD

The invention relates to the use of a cellphone to read and change an electronic display via the use of sounds.

### BACKGROUND

Current electronic screens used for advertising include electronic billboards, and screens displayed in shop windows. Very few, if any, of these are used in an interactive manner, where the content of the screen can somehow be altered by a pedestrian. In our earlier submissions we described how to do this with existing hardware in a minimal arrangement.

Recently, researchers Bergel and Steed at University College London released a product “Chirp” (cf. Chirp.io) that encodes data, like an URL, via what they term a shortcode as a short sound resembling birdsong in an audio range audible to humans. Cf. their US Patent Application 20120084131, “Data Communication System” [Bergel].

A device, like a cellphone or personal computer, encodes and emits this Chirp. Another device nearby might be able to detect this and, with the appropriate decoding or demodulating hardware and software, convert it to an URL, assuming that the decoded data is of this form to begin with. The detecting device would typically be a cellphone, inasmuch as it could intrinsically record audio. Then the software would launch a browser with that URL, if the device had Internet access, via either a phone carrier or a nearby WiFi or WiMax hot spot or some other wireless means.

The fundamental insight of Bergel used the longstanding idea of representing an arbitrary length bit sequence by a usually much shorter hash. Bergel also used the observation that the simplistic encoding of the former sequence as sound resulted in a lengthy sound, which was harder to transmit and receive. Instead, if the hash was encoded as sound, then the transmission of this was equivalent to transmitting the original signal, provided that the receiver could take the decoded hash and somehow map it back to the latter. The much shorter length of the hash resulted in a sound (aka. Chirp) that was in turn much shorter in temporal duration, and thus quicker to transmit and receive.

### SUMMARY

A chirp is emitted from a speaker associated with an electronic screen. The chirp encodes an URL with an id of the screen. A user with a mobile device decodes the chirp and controls the screen. The web server associates the mobile device with the screen, and sends web pages to the mobile device. Links in the pages cause the server to change the images sent to the screen.

A screen can have several speakers emitting different chirps. The decoding by a mobile device is used by the server to allocate a split screen to the device that is closest to it.

A screen has a microphone that decodes a chirp from a mobile device. The chirp encodes an URL with an id of the mobile device. The screen sends the URL to the server, which lets the mobile device control the screen.

A blacklist is applied by a mobile device to a decoded chirp, where the blacklist can be a function of the date and location of the device.

A chirp header has bits that define a hop (rebroadcast) count. A device decoding a chirp can decrement and rebroadcast.

The querying of an audio server by a mobile device, to decode a chirp can be minimised, for faster decoding. The header has bits pointing to a key in a table in the audio server. The corresponding value is an URL prefix, for a company with devices emitting chirps with this common prefix. The prefix can be cached by a mobile device. Subsequent chirps having the same key let the device use the cached prefix instead of calling the audio server.

The header can have bits that define common protocols used in an URL. This can be used to omit those protocols in the body of the chirp, freeing up space in the overall length of the chirp.

A device connected to the Internet runs a web server. The device lacks a screen. It emits a chirp wrapping an URL. A mobile device decodes the chirp and gets web pages to control the device or show data from the device.

A pair of mobile devices that are connected to each other, where one device can play a chirp and the other device can take a picture, can interact with a second pair of mobile devices, where one device of the latter pair can record audio and the other device can show a barcode.

### BRIEF DESCRIPTION OF THE DRAWINGS

FIG. 1 shows Jane using her mobile device to read and change the screen.

FIG. 2 shows Jane's mobile device getting a chirp from the screen.

FIG. 3 is a top view of a mobile device near a screen with 2 chirp transmitters.

FIG. 4 shows Jane's mobile device emitting a chirp to the screen.

FIG. 5 is a flow chart of the decoding of a chirp.

FIG. 6 shows Jane's mobile device interacting with a screenless device.

FIG. 7 is an interaction between 2 pairs of devices.

### DETAILED DESCRIPTION OF THE PREFERRED EMBODIMENT

What we claim as new and desire to secure by letters patent is set forth in the following claims.

This submission refers to our earlier submissions to the US PTO: “A cellphone changing an electronic display that contains a barcode”, filed 16 May 2011, Ser. No. 13/068,782 [“1”]; “Using dynamic barcodes to send data to a cellphone”, filed 28 Jul. 2011, Ser. No. 13/136,232 [“2”]; “Barcode and cellphone for privacy and anonymity”, filed 4 Oct. 2011, Ser. No. 13/200,849 [“3”]; “Colour barcodes and cellphone”, filed 16 Dec. 2011, Ser. No. 13/374,207 [“4”]; “Uses of a projector phone”, filed 6 Jan. 2012, Ser. No. 13/374,659 [“5”]; “Mobile device audio from an external video display using a barcode”, filed 25 May 2012, Ser. No. 13/506,921 [“6”]; “Dynamic group purchases using barcodes”, filed 29 May 2012, Ser. No. 13/506,957 [“7”].

Below, we shall consider the case of a user having a mobile device, where often this can be a cellphone. But it could also be other types, like a tablet or notebook or electronic book reader, with the capabilities attributed to the cellphone.

We shall use examples of an Internet Address version 4. The examples can be generalised to IPv6.

We will describe the use of 2 dimensional barcodes. Examples of these include QR and Data Matrix codes. But other types are possible, including 1 and 3 dimensional formats.

The submission has the following parts:
1. Base implementation;
2. Independent screen;
3. Blacklist and whitelist;
4. Header;
   4.1 Rebroadcast;
   4.2 Audio server table;
   4.3 Protocol;
5. No screen;
6. Multiple devices;
7. Audio server actions;

1. Base Implementation;

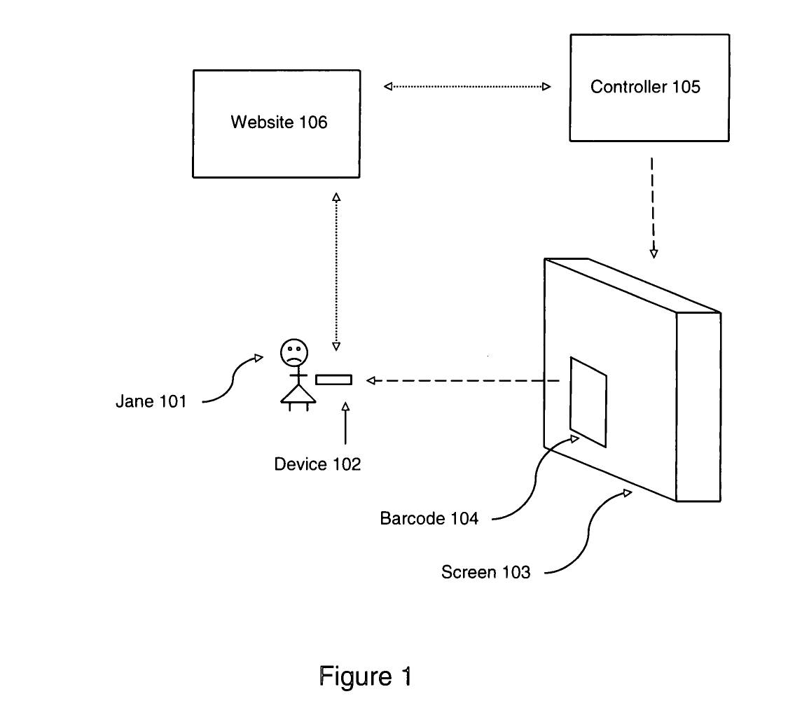

Consider FIG. 1, which is taken from FIG. 1 of submission “1”. Jane 101 is a user with a Device 102 that has a camera. She is near Screen 103. This is an electronic screen that shows an image. The screen is controlled by Controller 105. The latter is a computer, or contains a computer, that sends various control commands and data to Screen 103, including the image to be shown. Often Controller 105 is in close proximity with Screen 103. It might communicate with Screen 103 by wired or wireless means. Or, in another implementation, Controller 105 and Screen 103 might be combined into one device; akin to a personal computer and its screen.

Note that Jane 101 has no access to any typical (in the state of the art) input peripherals or mechanisms of Screen 103 or Controller 105. This includes a keyboard and mouse. But also a keypad, trackball (essentially an upside down mouse) and light pen. Also Jane 101 cannot touch Screen 103, so even if Screen 103 is a touch screen, she cannot access it via this means. Plus if Screen 103 and possibly Controller 105 have one or more of these peripherals or mechanisms, they are considered to be only accessible by a system administrator or other personnel maintaining the machine/s. In this case, the input peripherals would be typically in another location, like a back room of a shop.

Screen 103 shows some image, where this includes Barcode 104. This is typically a 2 dimensional barcode. Often, the rest of the image can be something of semantic meaning to Jane. (Though a degenerate case is where the image only consists of Barcode 104.) The meaning induces her to point the camera of the Device 102 at Barcode 104 and take a picture.

Device 102 decodes the image into an URL. Device 102 is assumed to have wireless access to the Internet, such that it goes to the URL address, which is at Website 106, and downloads the webpage at that address and displays it in the Device 102 screen, in a web browser. Between Device 102 and Website 106 are several machines, like those of the cellphone network and, once the signal goes on the Internet, various Internet routers. These are omitted for clarity, because they can be considered to just passively pass the signal through, and do not take an active role in this invention.

The steps in the previous paragraph are well established state of the art. Device 102 can be instantiated as a cellphone having the necessary hardware, and made by Apple Corp., Samsung Corp., Nokia Corp., LG Corp. and others. There is software available for performing the barcode decoding and the other operations in the previous paragraph. Typically the software decodes a QR barcode. The software has been written by third parties, i.e. not by the phone manufacturers and not by us. Currently, the phone manufacturers do not include such software as part of the pre-existing software on their phones, though this may change in future. The third party software is available freely or for a nominal cost to be paid by the phone owner.

In submission “1”, Website 106 instead of or in addition to replying to Device 102 with a webpage, now sends a signal to Controller 105. The latter makes a change in the image on Screen 103. There is a feedback loop that makes Screen 103 interactive. Jane uses her Device 102 as the remote control for Screen 103, without needing physical access to Screen 103.

The possible applications include Screen 103 being in the window display area of a shop, with Screen 103 facing the street. Jane is a pedestrian who can now scan the shop's catalog, for example, if it is put on Screen 103 with the appropriate controls downloaded to her Device 102. Or Screen 103 can be dangling from the ceiling in a restaurant or sports bar. Or Screen 103 can be in an airport, museum or library. Or Screen 103 can be an electronic billboard, above a major street or shopping area. Then a pedestrian photographing the barcode in Screen 103 can change the billboard.

In the rest of this submission, we will simplify our notation by using “Screen” to refer to Screen 103. And “Website” will be Website 106.

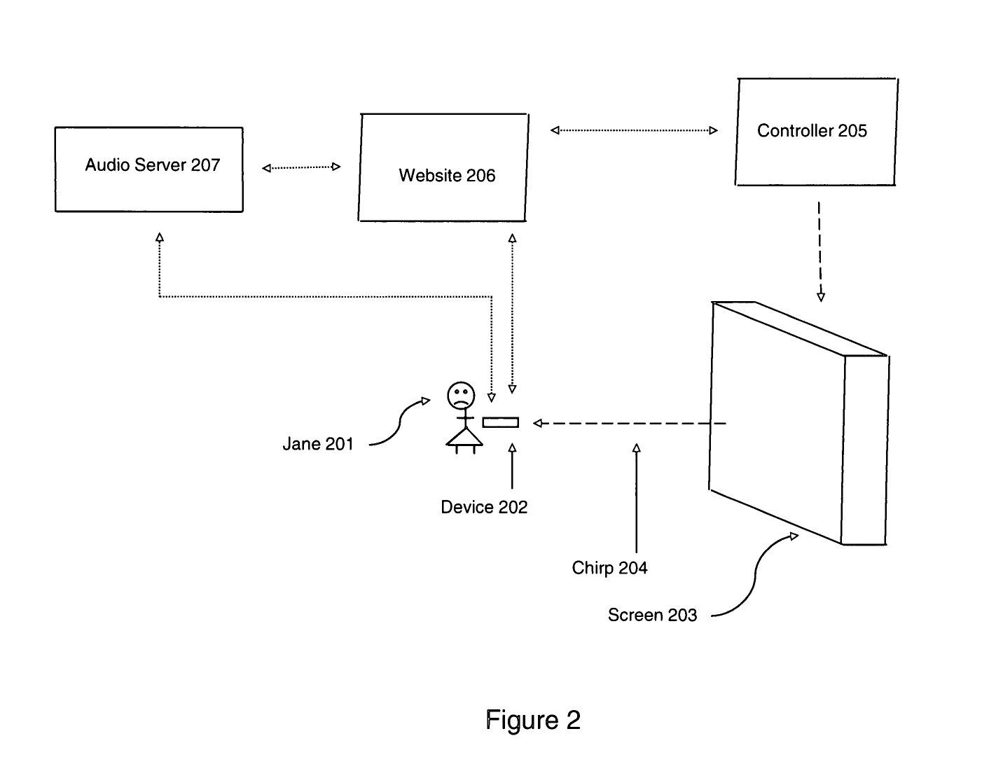

We extend Bergel in the following ways. See FIG. 2. It is similar to FIG. 1. But in FIG. 2 there is no barcode. Instead, Screen 203 is assumed to have an associated audio output device, which is not explicitly shown. That device outputs the audio signal Chirp 204, which is detected and decoded by the mobile Device 202. If the audio signal is encoded via the method of Bergel, this decoding requires the use of Audio Server 207. The original data, which is an URL in the context of this submission, was at an earlier time sent by Website 206 to Audio Server 207. The URL points to Website 206. Audio Server 207 makes the shortcode. This might be done via applying a hash function to the data. Or by some other means that makes a bit sequence.

Audio Server 207 stores both the original data and the shortcode in what is effectively a hashtable. In this table, the shortcode is the key and the URL is the value pointed to by the key. Audio Server 207 returns the shortcode to Website 206, which makes an audio signal from it and transmits the audio signal to Controller 205. In turn, the latter sends it to a speaker associated with Screen 203, and the speaker emits Chirp 204.

Device 202 receives and decodes Chirp 204 into the shortcode. Device 202 makes a direct network connection to Audio Server 207 (more on this below), and sends it the shortcode. Audio Server 207 returns the URL, which refers to Website 206. Device 202 opens a browser and loads it with the URL, which triggers a query to Website 206. As in FIG. 1, there is a feedback loop between Website 206 and Screen 203. Controller 205 is considered to be the computer that directly controls Screen 203. This lets Jane 201 use Device 202 to control the images on Screen 203.

In the previous paragraph, we said Device 202 queries Audio Server 207. The application on Device 202 that does this is assumed to have the network address of Audio Server 207. The latter is considered to be a machine known a priori to mobile applications that want to use it. So the shortcode decoded on Device 202 does not need in itself the address of Audio Server 207.

One variant is where when Audio Server 207 gets the query from Device 202, instead of returning the URL to Device 202, it makes a query to the URL server, where the return address is the Internet address of Device 202. Here Audio Server 207 acts as a redirector. This has the advantage of removing one remote interaction across the Internet from the previous steps, and can speed up the overall experience of Device 202.

Bergel uses “chirp” in 2 closely related meanings. The first is the name of the overall protocol of their submission. The second is the name of the audio signal. We use “chirp” in the second meaning in our figures and text. This is done for a consistent terminology across the submissions, and because “chirp” is a useful evocative term.

Hence the audio encoding of an URL can be used with the closed loop of FIG. 2 to enable many (but not all) of the applications discussed earlier in our submissions “1”-“7”, in place of the barcode encoded URL. Consider 2 examples. First, the URL has an id field that refers to Screen 203. Where Website 206 maintains a table that maps the id values to specific instances of Screen 203. Here, it is assumed that Website 206 and the multiple Screens 203 are owned or run by the same organisation. When Website 206 gets the URL from Device 202, Website 206 extracts the id and uses it to associate Device 202 with a specific Screen 203 (and its specific Controller 205), and to give Device 202 web pages that let it control that Screen 203.

The second example is where Screen 203 and its Controller 205 are not known a priori to Website 206. One scenario is where Screen 203 and Controller 205 together constitute an arbitrary computer on the Internet. Unlike above, Jane might have physical access to Screen 203 and its input peripherals. She brings up a browser on Screen 203, by using those input peripherals, and goes to a webpage of Website 206 by typing an URL of Website 206. When Website 206 gets that query, it generates the webpage. It makes an URL that has encoded the Internet address of Controller 205. As earlier, it registers this URL with Audio Server 207 and gets a shortcode. Website 206 makes a chirp and embeds this in the webpage it sends to Controller 205. The webpage is send shown on Screen 203 and the chirp is played as audio output from Screen 203's speaker.

The webpage might have the property that it plays the chirp only once. Where perhaps a refresh of the page will replay the chirp. Or the page might play the chirp continuously, with some quiet time between each playing.

Device 202 records the chirp and decodes it into an URL, as was done earlier. When Website 206 gets the URL from Device 202, Website 206 uses that encoding standard to extract the Internet address of Screen 203. Thus Website 206 can associate Device 202 and Screen 203. Website 206 sends web pages to Device 202 and corresponding images to Controller 205, that the latter will show on Screen 203. When the user clicks on various links or buttons on Device 202, or performs various actions (e.g. if Device 202 is a cellphone with a touch screen or sensors that can detect user actions or the motion of the device), then these will be sent to Website 206, which can cause the images on Screen 203 to change in response.

The 2 examples show that broadly, if Device 202 can successfully decode a chirp, then the overall steps are equivalent to using a barcode URL.

One difference with submission “1” is that Chirp 204 is not line of sight. Hence Jane could take control of Screen 203 even if she cannot see part or all of the screen where a barcode might appear. In general, this may be seen as undesirable by the retailer, because the main motivation of making the screen available for control by a user is where the user can see the resultant changes on the screen. If the screen is changed by a user out of the line of sight, then to any users in the line of sight, who might be unable to alter the screen, the screen is effectively acting as in the state of the art, where no such control is possible.

The above software on Device 202 clearly has overlapping functionality with that on Device 102. The only difference is that the Device 202's software can decode a chirp, while Device 102's software can decode an image of a barcode.

The use of the chirp can be expected to take longer than using a barcode. The barcode can be decoded entirely in Device 102. For example, applications have been written for the recent smartphones made in 2012 by Apple Corp. and Samsung Corp. that can perform this internal decoding. In contrast, in FIG. 2, when Device 202 gets the audio input, it can decode this into a shortcode. But the query to Audio Server 207 goes over the network, to where ever it is physically located. The delay is the amount of time from the sending of the shortcode to when Device 202 gets the URL reply. This can be expected to be mostly due to the transmission times on the network. Since the actual lookup from the shortcode to the URL in Audio Server 207 can be expected to be quick. Hashtable lookups are usually fast, compared to transmission times. Though even here, depending on the workload of Audio Server 207, the lookup might occasionally be lengthy.

Our use of chirps is not limited to the particular encoding method by the above researchers, but pertains to any audio encoding scheme.

Note that there is a distinction between chirp audio from the Screen that refers to an URL, and any audio that might come from a web page downloaded to Device 202.

There are limitations to the use of chirps. In the case of Screen 203 being deployed in a shop window, facing the street, there might be no means to emit the audio. Because speakers would have to be placed exposed to the street, and then subject to damage or loss. Or if Screen 203 is in a bar that plays loud music, the chirp might not be able to be decoded over the sound of the music.

Other usages could allow the use of chirps, whereas the use of a generic audio broadcast might be subject to restrictions. For example, consider a billboard. It could have a loudspeaker playing audio about the visual contents of the billboard. But this is rarely done in practice, due in part to the prospects of the audio being consider noise pollution. In contrast, if the chirp sounds like birdsong, it opens the prospect that the pleasing aesthetics of this might avoid the signal being considered noise.

Note that the use of audio requires extra hardware compared to our earlier method of submission “1” that strictly uses a barcode. In general, the transmitter associated with Screen 203 is an explicit extra device. In some circumstances, if Screen 203 has a built in speaker then this might be used. Like if Screen 203 is in a sports bar or restaurant, out of reach of patrons, but where there is no glass separating it from them.

The data encoded in Chirp 204 need not be restricted solely to an URL. There might be a format used that permits other parameters. One implementation is for the format to be XML, like

<d>

<a>http://somewhere.com/id=5</a>

<b>1</b>

</d>

Here, the <d> field encloses the entire text to be mapped to a shortcode. The <a> field is the URL. The <b> field represents another parameter. There could be more parameters.

Instead of XML, another format could be a series of parameter=value pairs, like

a=http://somewhere.com/id=5;

b=1;

One of the parameters might be a rebroadcast option. When this is true, the decoding Device 202 will rebroadcast the audio, assuming that it has the dynamic range in its output to be able to do so. Rebroadcasting lets the audio travel to other users whose devices might be out of range of the original audio.

Device 202 directly contacts Audio Server 207 to extract the URL. If rebroadcasting will be done, it can do this instead of also sending the URL to Website 206.

Screen 203 could have the ability to show a barcode and to play a chirp. Both do not have to occur at the same time. And the data encoded in each do not have to be the same. While FIG. 2 does not show a barcode, the inclusion of this is an obvious combination of FIGS. 1 and 2.

Suppose initially there is no Chirp 204. Screen 203 shows a barcode. Device 202 decodes it, sends it to Audio Server 207, gets the shortcode, converts it to a chirp and broadcasts the chirp. Here, the barcode might simply encode an URL. Or it might encode an URL with other parameters, as discussed above. This shifting from an input barcode image to an output audio is likely more useful than the opposite, of Device 202 decoding an audio input and outputting (“rebroadcasting”) a barcode on its screen. Because emitting audio and having another device record it is non-line of sight, so the Device does not have to be aligned with another device that is intended to record the chirp. While the display and recording of a barcode is line of sight, and given the small screen if Device 202 is a cellphone, it is in practice restricted to being visible to only one or two other devices at a time.

Suppose Screen 203 shows a barcode and plays a chirp. The barcode might not be a static (time invariant) image. It could be a dynamic (time varying) image, as per our submission “2”. The chirp could cause Device 202 to show a web page with controls that can vary the properties of the dynamic barcode. Like the resolution of the individual barcode frames. This is equivalent to the use of static and dynamic barcodes in submission “2”, where the static barcode produced a web page to control the properties of the dynamic barcode.

One scenario of the use of a chirp and the dynamic barcode is where Device 202 records the chirp and alters the properties of the dynamic barcode, where there are other users nearby who then use their mobile devices to scan the dynamic barcode.

If Screen 203 broadcasts Chirp 204, this could be from one or more speakers. If there are 2 speakers, it could be because Screen 203 was meant for a general usage of playing stereo sound.

Suppose Screen 203 is not playing the chirp, but it shows a barcode URL. Jane uses Device 202 to get control of Screen 203. There could be buttons on her web page that let her turn on the left and right speakers. And to adjust the volumes. And to adjust the orientations, if the speakers can pan. There could also be controls to turn off a speaker. The remarks of this paragraph also apply if Screen 203 played a chirp that Device 202 was able to capture.

If Screen 203 uses 2 speakers, these could play different URLs. For example, the left speaker could have a field in the URL that says “i=1”, while the right speaker's URL differs in having “i=2”. Then, when Device 202 decodes a given audio and forwards the URL to Website 206, the latter knows which speaker it came from. If Screen 203 has more than 2 speakers, then the values might be extended accordingly to designate the speaker of origin. If Screen 203 also shows a barcode, when the barcode URL might omit this variable, or it might include it, giving it a value unused by the chirps.

This can be useful. In submission “6”, we discussed how a screen can have split screens. In this case, a question arises about how to allocate a given split screen to a user? In “6”, we suggested that if the user's device location is known accurately enough, relative to the screen's location and orientation, then the user should get a split screen closest to her, if possible. In the current submission, if Device 202 gets the audio from the left speaker, then it might get to control a split screen on the left side of the screen.

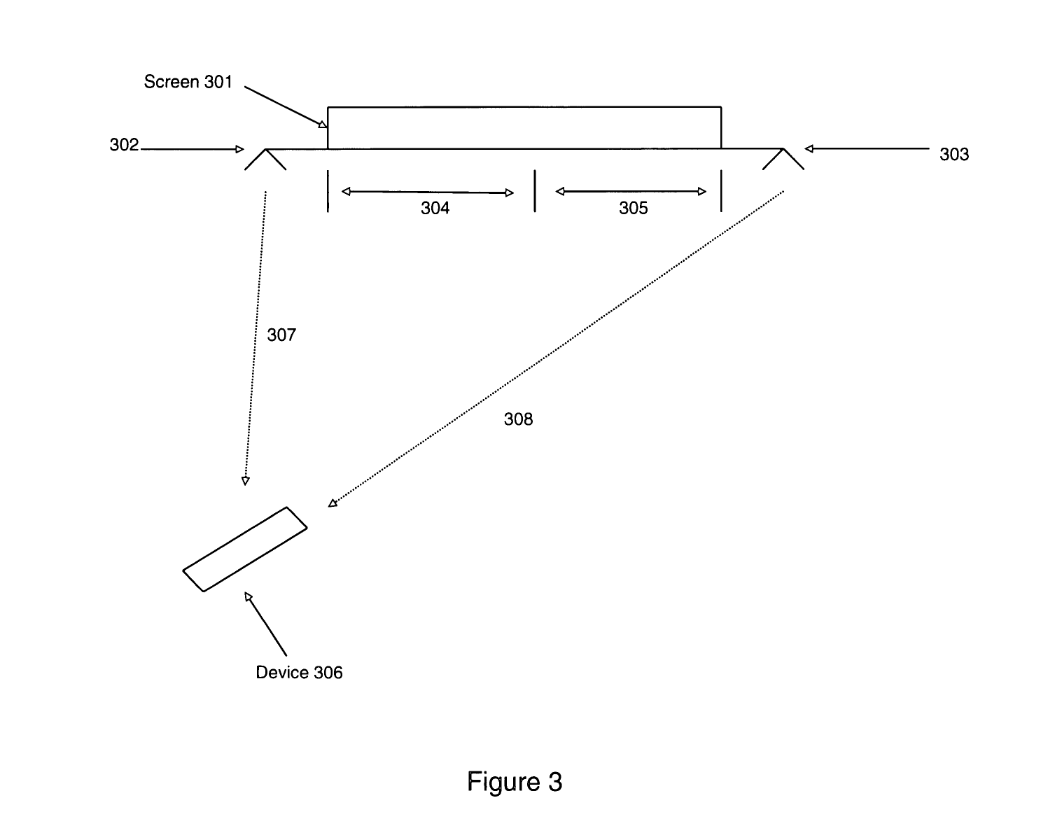

FIG. 3 depicts this. It shows a top view of the interaction between Screen 301 and mobile Device 306, where the latter corresponds to Device 202. Screen 301 has a left speaker 302 and a right speaker 303, where left and right are defined as seen by a user facing the screen. The user is not explicitly shown in FIG. 3, but Device 306 is imagined to be held by that user. The left speaker 302 emits a chirp 307 which is received by Device 306. The right speaker emits a chirp 308 which is received by Device 306. Screen 301 is shown as having 2 split screens, a left split screen 304 and a right split screen 305. These split screens are either imagined to not yet exist, and will be made as a result of the current interaction. Or the split screens already exist and are unallocated, or they are allocated, and one of them will be reallocated to Device 306.

In FIG. 3, it is supposed in this example that because Device 306 is closer to 302, chirp 307 will be of stronger strength than chirp 308 at Device 306. Thus split screen 304 will be allocated to the control of Device 306.

This is not foolproof. For example, Jane might be standing closer to the right speaker. But if there are people standing between her and it, they might absorb much of the audio from that speaker. So her device ends up decoding the audio from the left speaker. But given such caveats, the method of using different audio signals to allocate a split screen can still be used, for its overall simplicity and rough accuracy.

In FIG. 3, consider again when Device 306 gets chirps 307 and 308. It sees the superposition of both signals. Though it can be supposed that if the chirps are played at the same time from the speakers, chirp 307 will arrive first at Device 306. The chirps could be designed so that a receiving device can separate the two by frequency analysis.

Now imagine that Device 306 extracts chirp 307 while chirp 308 is still being processed. It makes a query with the shortcode from chirp 307 to the audio server. Device 306 could have logic to discard a second chirp that arrived while it was processing a first chirp. But suppose Device 306 did also finish getting chirp 308 and it then proceeded to get the shortcode and query the audio server. So ultimately the web server for both shortcodes gets 2 queries in short order from the same Device 306. The web server knows that these correspond to the left and right speakers. Hence it can interpret this as really one request from a device unable to reduce its requests to one such. The web server can discard the second, later request from the same device, where this second request arrives within some time limit after the first.

If Screen 203 plays Chirp 204, but does not show a barcode, then the web page downloaded to Device 202 could let Jane tell Screen 203 to show a barcode.

In FIG. 2, suppose Jane has gotten control of Screen 203, via decoding a chirp or a barcode. Suppose there is no split screen. Others are nearby who can see her interact with the Screen. They might want to hear audio from their mobile devices. This is not the chirps but any “normal” audio track that accompanies the images on Screen 203. Jane can allow this via controls on her phone web page, that let her instruct Screen 203 to broadcast a chirp, where this is for a web page that will download audio that is played on a user's device. Jane might also be able to turn off the broadcasting of the chirp.

In submission “6” we discussed how the first person, Jane, to control a screen might be able to control how the screen will or can be split into split screens for others to also control. In the current submission, the web page on Jane's device might let her pick a chirp that will show a web page with at least 2 options: One is for the user to listen to the audio from Jane's screen, as in the previous paragraph. The other will make split screens in Screen 203, and allocate one split screen to the user. Or, if split screens already exist, then one will be allocated to the user, if it is vacant or if an existing user will be deallocated.

A variant is for 2 chirps to be broadcast sequentially by Screen 203. One gives a web page where the user can pick a given split screen to listen to. The user then gets an audio track played on his device, for that split screen. The other chirp gives a web page from which by picking a selectable item, like a button or hyperlink, where the user gets the control of a split screen. The 2 chirps might be broadcast only once or repeatedly.

The use of chirps has a disadvantage vis a vis barcode URLs in some situations. Consider when there are 2 nearby screens, each emitting its own chirp. When Jane uses her device to detect the chirp for a particular screen, she might get the audio from the other screen. Especially if she is standing at roughly equal distances from both. With barcodes, there is no ambiguity (if correctly implemented). When Jane takes an image of a barcode on a screen, then her device gets control of that screen, and not of any other.

Using a chirp has an advantage over a barcode for some users who are visually handicapped or who have neuromuscular conditions that preclude them from easily taking their mobile device and focusing its camera on a barcode on a screen.

In our submission “7” we described the use of barcodes on an electronic screen in a movie theatre, where the screen might be on a sidewall. Or mounted between the sidewall and the main projection wall. For ergonomic reasons, it might be difficult for a patron sitting in an inside row to image the barcode, if there are patrons sitting nearby around the line of sight to the barcode. If a chirp is used, instead of or in addition to the barcode, then this gives another means of her obtaining the URL that is not line of sight.

Also, submission “7” described the use of a mobile electronic screen or billboard. This might be on a vehicle trailer platform and towed by a truck or car. The screen would show in part a barcode and a table or graphics of items for sale. A pedestrian or passenger in a nearby vehicle can use her mobile device to take a photo of the barcode. Which would then unfold to a web page on her device where she could buy an item. In submission “7”, the preferred context was where the mobile screen was towed somewhere and parked, preferably in front of a crowd of potential customers. In part, the reason for the screen to be stationary was that this is easier for a pedestrian to focus her device camera on the barcode, rather than trying to track the barcode on the moving screen.

In the current submission, the screen emits chirps. This could be easier for the pedestrian's device to detect, inasmuch as no manual tracking is needed of the screen. The chirp emission could preferably be done in addition to the screen showing a barcode, to maximise the possible total customer usage.

The Doppler effect was first discovered for the movement of an audio source relative to the observer. In the current usage, the screen would be expected to be moving relatively slowly that this frequency shift should be minimal. Or the decoding software on the device could take into account any Doppler shifting.

2. Independent Screen;

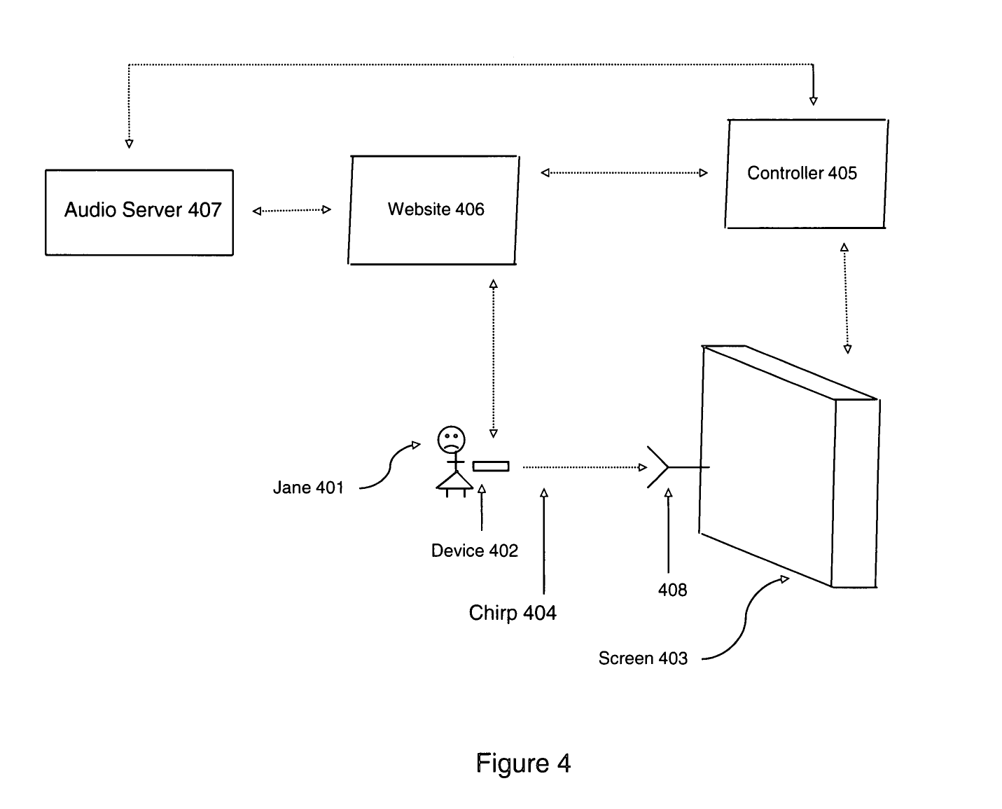

Consider FIG. 4. This is the inverse of FIG. 2. The scenario is that Jane 401 has Device 402, and the latter already knows Website 406 and has obtained from it a chirp. Device 402 is assumed to have an Internet address, and when it contacted Website 406 to request an URL, Website 406 stored the association between a parameter value that will go into the URL, and the address of Device 402. Thus the URL might have a field like “k=6”, where k is the parameter and 6 maps to the address of Device 402. Website 406 might be doing this for several different Devices 402, so it needs to associate between each such device's Interne address and some internal id, like k in this example.

An alternative formulation is where the address of Device 402 is explicitly encoded into the URL. Suppose Device 402 has the address 20.30.40.50. Then the URL might have a field like “k=20-30-40-50”. (Similar remarks might be made for IPv6 addresses.)

In either case, Jane 401 with Device 402 walks near Screen 403. She wants to control it with her device. Screen 403 is assumed to be controlled by Controller 405. In general, there has been no prior communication between Controller 405 and Website 406. When Website 406 made the URL, it sent that URL to Audio Server 407, which makes a shortcode and returns that to Website 406.

A variant is where Website 406 sends the actual URL to Device 402, and the latter uploads the URL to Audio Server 407 and gets the chirp in return.

Also, Screen 403 is assumed to have a microphone 408 that can pick up an audio signal. Jane walks within range of the microphone 408 and presses a control on her Device 402 that emits Chirp 404 that she got from Website 406. Or Device 402 got a shortcode from Website 406 and converted it to Chirp 404.

Screen 403 passes this to Controller 405. Which has a program running that takes this as input, decodes it using a query to Audio Server 407, and makes a network connection to the URL. Website 406 gets the request, parses it, and hence makes an association between Screen 403 and Device 402. Website 406 returns an image to Controller 405, which displays it on Screen 403. Also, Website 406 pushes a web page to Device 402, where the page has controls for the image on Screen 403.

Note that the data that Website 406 returns to Controller 405 can simply be an image in a standard format that can be shown on Screen 403, like JPEG, GIF or TIFF or perhaps as a set of “raw” RGB values for each pixel on the screen. There is no need per se to send an HTML page to Controller 405, because Screen 403 has no input devices, other than the microphone, that can be directly accessed by Jane. But a variant is where an HTML page is sent and then displayed.

A variant is where there is a button near Screen 403, which Jane presses to turn on the microphone. Or there might be some other sensor with equivalent effect. Jane then has her Device 402 emit the audio.

A variant is where Device 402 makes a barcode of the URL on its (small) screen. Screen 403 is assumed here to have a camera that can record this barcode, which it sends to Controller 405 for decoding and to make the closed loop with Website 406.

In any event, Jane can control Screen 403 subsequently in the same way as in submission “1”.

The business reason for FIG. 4 differs from FIGS. 1 and 2. In the latter 2, it is assumed that the web server and the screen are owned by the same entity. The deployments, like in a shop window or where the screen is an electronic billboard, are to induce interactions and to show advertising for the owner. In FIG. 4, Controller 405 might require payment from the user or from the website. Instead, or in addition to this, Screen 403 might show advertising from other entities.

This advertising that emanates from Controller 405 can have another consequence. Controller 405 might send signals to Website 406 that ask it to modify the web pages it sends to Device 402, such that on those pages Jane can pick the Controller's ads, in addition to whatever else are her normal direct interactions with Website 406's content. In FIGS. 1 and 2 this was moot, because the controller was part of the same company that owned the website.

Or Controller 405 might modify a web page it gets from Website 406, so as to insert ads from third parties.

In FIG. 4, thus far it was assumed that Jane got sole control of Screen 403. But suppose a second user, Bob, approaches the screen. He has a mobile device associated with another website, in the manner that Jane's Device 402 is associated with Website 406. Bob also wants to use Screen 403. One way is for Screen 403's microphone to be on. The screen listens for audio input. Bob's device emits an audio signal, in the same way as Jane's, and this is captured by the microphone and sent to Controller 405.

If the latter allows split screens, and if any necessary payments are made by Bob's device or his website, then 2 split screens are made. One allocated to Jane and the other to Bob.

An alternate method for Bob to get a split screen could be via his device showing a barcode on its small screen, and Screen 403 having a camera that images the barcode, as Jane might have done earlier.

A special case of FIG. 4 is where Website 406 and Device 402 are the same. The mobile device has an Internet address and is its own web server. In this case, it can also be assumed that the web server only supports this one instance of Device 402. So the URL that it makes can be simpler than that used at the start of this section. The URL need only refer to the device's Internet address, and perhaps some few characters to the right of that. There is no need for the “k=” mentioned above. When Screen 403 and Controller 405 gets the URL from the chirp, when Controller 405 communicates to Device 402 using the URL, then Device 402 inherently gets Controller's address.

3. Blacklist;

When Device 202 decodes a chirp or a barcode URL, it could apply a blacklist and whitelist to decide if it will go to that URL. The lists could be a function of device location and time. This differs from the use of blacklists and whitelists for email, where those rarely if ever have any space or time dependence.

A variant on this is to consider Audio Server 207. When it is initially presented with an URL by some other machine, like Website 206, it can apply a blacklist or a whitelist to the domain in the URL. Given that Audio Server 207 is assumed to be a well known and presumably reputable machine, it can aid its reputation by performing this filtering. The blacklist might be more important. If a submitted URL (or if a compound message like the examples above has an URL field) has a domain in the blacklist, a shortcode is not generated. Instead, some type of error message might be returned. This assumes that the blacklist is a standard blacklist, with no time or space dependence.

When Audio Server 207 applies the blacklist, it frees up the need for Device 202 to do so, assuming that both entities would use the same blacklist.

If the blacklist has space and time dependence, then when Website 206 presents an URL with a domain in it, Audio Server 207 might make and return a shortcode to Website 206, and make an entry in its table. Later, when some Device 202 sends the shortcode to Audio Server 207, it finds the URL from its table. It checks the URL against the blacklist. If the date and time is in a prohibited range, then it returns an error message to Device 202.

If the blacklist has prohibited regions, then Audio Server 207 might take the network address of Device 202 and test if the address is in a prohibited region. This might only be able to be done coarsely. For example, if Device 202 accesses the network via a phone carrier, then the network address may be associated with an office of the carrier in the same city as Device 202. So in this case, the location of Device 202 is known only down to city resolution. But if the prohibited regions of the blacklist are broad enough, this could be sufficient accuracy to apply the blacklist.

Or if possible, Audio Server 207 might send a message to Device 202 asking for its location, or this information might be sent by default by Device 202 when it queries Audio Server 207. This assumes that Device 202 has knowledge of its location.

There is a special and important case of an expired URL that is related to the idea of a domain in the blacklist having a time range of validity. There may be a need for Website 206 to generate an URL with an index that refers to a time interval. For example, the index might be “h=8301”, where “h” is the example name of the index. The value is valid for a given time interval, starting at a specific time and continuing for, say, 20 minutes. In the next time interval, another value might be randomly generated from some range of values. Because if a time independent URL is used, suppose a user decodes the chirp (or decodes a barcode) and who then saves the URL, might use it at a later time, when she is not near Screen 203. The URL is still valid, and she gets control of the screen, assuming that no others are currently using it. In general this is unwanted, since priority should be given to users in sight of the screen.

To prevent this, a time index can be used, as above. Now consider what this can mean for a chirp. When Audio Server 207 gets an URL from Website 206, it might also get an accompanying start and stop time for its validity. If the start time is omitted, then by default the URL can be assumed to be immediately valid.

Audio Server 207 makes a shortcode and returns it to Website 206. And Audio Server 207 puts the shortcode and URL into its (main) table. Along with entries for the start and stop times. There might be a process that runs periodically on Audio Server 207 that inspects the table for expirations. When an entry expires, Audio Server 207 removes it from the main table, and puts it into an “Expired” table. This helps reduce the size of the main table.

Also, when Audio Server 207 gets a shortcode from Device 202, it checks its main table, as before. If there is no match, it checks the shortcode against the keys of its Expired table. If there is no match, then it returns an error message to Device 202, e.g. “Unknown shortcode”.

But suppose there is a match. Audio Server 207 can return some kind of error or status message to Device 202, indicating such a result. Or it might more usefully send the extracted URL from the Expired table, along with the network address of Device 202, directly to Website 206. Here, Audio Server 207 acts as a redirector. But the main reason for doing so is not to reduce the latency seen by Device 202.

Because even though the URL has expired, Website 206 could want to send a more informative page to Device 202. It might be presumed that Device 202's user should still be supported in some manner, even though she will not be given control of Screen 203. Jane 201 may have earlier been near Screen 203, which is how she got the chirp. She walked away. Now she still wants to look at Website 206's catalog or see whatever else that would have been shown on Screen 203. Lacking access to Screen 203, she wants to do it on her Device 202. Or another case is where she emailed the URL to herself (or someone else). So now she, or that other person, wants to access the URL on a device, which is not necessarily a (small) mobile device.

So it is important for Website 206 not to discard a query with an expired URL since the customer might still be interested. Website 206 might earlier have requested, when it uploaded the URL and its time range to Audio Server 207, that the latter redirect such expired URL queries and their originating addresses to Website 206. This could be a premium service by Audio Server 207 that it charges Website 206 for.

Audio Server 207 might have a maximum lifetime for entries in its Expired table. So as to put some limit on the size of this table. Entries that have been or would be in the table longer than this lifetime are (permanently) discarded.

Now consider the use of a blacklist or whitelist on Device 202, instead of or in addition to another blacklist or whitelist running on Audio Server 207. The latter 2 lists might be generic, inasmuch as they apply to all entries sent to the server. Whereas the lists on Device 202 could be specific to Jane. Her lists might come, in part or whole, from sources different to those used by Audio Server, where the latter might also generate its lists in part or whole from internal steps.

Device 202's lists could also be derived in part or whole from knowledge of Jane's habits or preferences. This might be done in part by letting her state these, including explicitly citing that, for example, she never wants to get chirps from a source owned by Home5 Corporation, while she always wants to get chirps from Store18 Corporation. Or Device 202 could have logic that analyses her usage and derives conclusions like those. Device 202 might use analysis done on Jane's other devices, if any, where the results of that analysis could be made accessible to Device 202.

A more fine grained approach is possible. Jane could explicitly tell Device 202 that she only never wants to get chirps from Store18 on weekends or when she is near one of its stores in her town. These are instances of time or location based blacklist entries.

If Device 202 has a blacklist and a whitelist for chirps, these could be derived from similar lists for, say, her web browsing or email usage.

If Device 202 has a blacklist and a whitelist for chirps, then when it sends a query to Audio Server 207, it might have settings in the query that ask Audio Server 207 not to apply its blacklist or whitelist. Perhaps because Device 202 only knows the shortcode or chirp prior to the query, then in general it does not know the source. It needs the result from Audio Server 207 before it can apply its local lists.

One variant is where Device 202 periodically or occasionally uploads one or both of its blacklist and whitelist to Audio Server 207. This requires that Device 202, or more generally Jane, maintains an account on Audio Server 207, which might be done via an identity, instantiated by a username and password. This also means that a routine query by Device 202 of a shortcode is accompanied by some type of login id and possibly an authentication.

4. Header;

In this section, we describe how the header of the shortcode might have bits allocated for2 purposes—rebroadcasting and distributed lookups.

4.1 Rebroadcast;

Earlier, we described Device 202 receiving a chirp and rebroadcasting it. There, the rebroadcasting was done upon detection of a rebroadcasting flag in the body of the decoded message. This required Device 202 making a query to Audio Server 207 and getting the message. Here, we describe a more efficient method.

If rebroadcasting is done, there might be the equivalent of a counter parameter that is decremented to zero, to place some limitation on the amount of times that rebroadcasting is done. Analogous to the limitation on hops in TCP/IP. This counter parameter might be present in the original audio from Screen 203, or it might be inserted by Device 202 into its audio output if the original audio did not have it.

However, as remarked earlier, it is also advantageous to minimise calls to Audio Server 207 as these can be slow. Suppose 3 adjacent bits in the shortcode header are allocated to a hop count. The value of these bits might be taken to be an unsigned 4 bit integer. When the value is 0, there is no rebroadcast. While if the value is 1 to 7, there is a rebroadcast. Here, crucially, the header is known to Device 202 when it decodes Chirp 204. The shortcode is considered to be the header plus a body. The body is essentially the hash which would be sent to Audio Server 207 to find the corresponding original message. Hence, Device 202 can rebroadcast without making a query to Audio Server 207. Device 202 would decrement the hop count before broadcasting, and in the header plus body, this is would be the only change compared to the shortcode it decoded from Chirp 204.

Unlike the Internet Protocol, which allocates 8 bits for the hop count, here there is suggested to be only 3 bits, which is a maximum of 7 rebroadcasts. Given that Device 202 is likely to be a cellphone, this 7 limit is seen as more realistic.

Rebroadcasting might be done using a different audio encoding from that of Chirp 204. One reason is that other mobile devices might not be able to decode the encoding that Device 202 was able to do.

4.2 Audio Server Table (AST);

The use of a global Audio Server in FIG. 2 (and FIG. 4) is implicit in Bergel if there is a requirement for a globally unique hash. But consider that many of the cited applications in Bergel and here are where the user has a mobile device, like a cellphone. A user would typically reside in a given region, like a city. And her using a globally unique shortcode is potentially a waste of the space of possible values of that code. This differs from, say, the use of a domain name on the Internet. In the latter, someone at a browser can be expected to go to a domain anywhere on the globe. Hence the need for globally unique domain names. The use of shortcodes is more similar to the use of radio frequencies for radio stations, where a given base frequency is reused in different regions. This is especially likely to be apt if the shortcode (or its equivalent chirp) comes from a screen owned by a retailer or advertiser. Because even if the owner is global, the shortcode is expected to refer to a server in the same region as the user, in order to minimise the latency of responding to the user.

First, this section suggests the use of a hierarchy of audio servers. There might be a global audio server that stores a hashtable, as per Bergel. It also takes a location input in a query and replies with a local audio server that serves a region containing the location. In turn, that local server might have servers under it that specialise in subregions. Hence, a user's Device 202 could hold and use the address of the closest audio server. Let this be Audio Server 207. In itself, this delegation to a relatively nearby machine would speed up the queries in Bergel and here.

Note that Device 202 might never, in some implementations, query the global audio server. An application running on it could be configured to know or use only the local audio server.

This section suggests the allocation of, say, 8 to 12 bits in the shortcode header as an index into an Audio Server Table (AST). The value is considered as an unsigned non-negative integer. If the value is zero, then we have the pre-existing situation; where the method of this section is not used. Suppose the value is non-zero. The value is an index into a short table held at Audio Server 207. Hence the term AST. If 8 bits are used, the table is 2**8−1=255 lines. If 12 bits are used, the table is 2**12−1=4095 lines. The value of an entry is the start of an URL, like “http://37.47.57.67/”.

For simplicity, we just use the example where the “start” of the URL is just the part up to and including the domain or raw IP address, plus a “/”. But in general, a table value could also have characters after the latter symbol that cause a descent deeper into the name space of the domain.

Different local audio servers, serving different regions, might have different sizes of their ASTs, and thus different numbers of bits allocated in the header for the index. Where, without loss of generality, we can take the size of an AST to be a power of 2 minus one. Hence an audio server for a large city like Chicago might have 12 bits of addressing, while the audio server for Topeka might have 8 bits.

At some earlier time, Audio Server 207, which is now taken to be a local server, has populated the table with those entries. Organisations, like retailers in the region, have (likely) paid to be included. They could be emitting chirps from screens or other devices in the manner of this submission.

Preferably, an entry would use a raw Internet Protocol address, instead of a domain name. This eliminates the need for a DNS query by end users. The company who has a given table entry would pick a machine it runs in the region, rather than say a machine in its national data center, which might be outside the region.

A company might have several entries in the AST. In this case, the entries might refer to the same or different IP addresses. In the latter case, the company could have several server machines in the region.

Now, suppose the company has a device that emits a chirp. The shortcode header has, say, an entry in these bits that is 55. The local Audio Server 207 maps 55 to “http://37.47.57.67/”. The body of the shortcode is what would append to that first part of the URL, in order to make a complete URL.

Note that in an AST, the positions of the entries do not have to imply any extra meaning. For example, the fourth entry is not meant to be better than or worse than the sixty first entry. Though as a practical matter, the ordering might have occurred via the earlier entries being filled first.

The audio server that runs an AST might offer a Web Service where the input is a domain, like somewhere.com. The output is the set of any entries in the AST that are owned by that domain. This lets a user's device query the audio server and find the local servers for a given company.

The audio server could offer a Web Service that takes as input a location (like the current location of a mobile device). It returns the entries in the AST for companies that are in the table and have emitters in a region around the location. The region might be, for example, a circle of radius 5 km centered on the location. As a simplifying matter, the emitters could be replaced by the condition of a company having stores in the region. This assumes the company is likely to have chirp emitters at those stores.

In turn, it assumes that the audio server has been furnished with such information from its clients in the AST, or the audio server has independently obtained such information.

In a similar way, a company like somewhere.com could offer a Web Service where the input is a device location, perhaps expressed in latitude and longitude. The output is the set of any AST entries for somewhere.com in the audio server region containing that location. Thus a mobile device could instead of querying the local audio server, just ask a company's server. This helps reduce the burden on the local audio server.

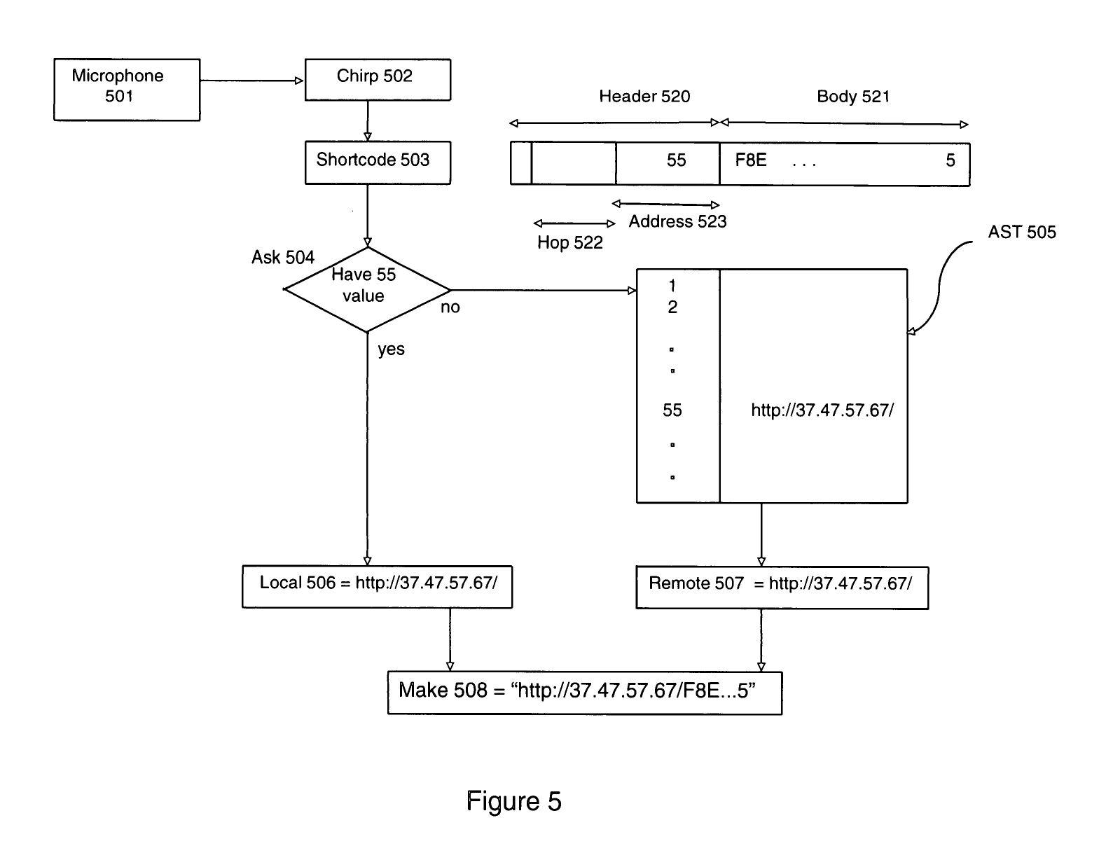

Consider FIG. 5. It shows a flow chart of steps that occur mostly in Device 202. First, Device 202 uses Microphone 501 to get Chirp 502. Then Device 202 decodes Chirp 502 into Shortcode 503. The content of the latter is shown adjacent to the label Shortcode 503. There is a Header 520 and a Body 521. In the header is a set of adjacent bits that constitute Hop 522 and another set of adjacent bits that is Address 523. Hop 522 is the bits for the hop (or rebroadcast) count. While the hop bits do not have to be adjacent to each other, and the address bits do not have to be adjacent to each other, this is a convenient choice. Hop 522 and Address 523 are shown next to each other, simply for convenience in FIG. 5. There is no necessity for this in an implementation.

Also, Address 523 is depicted as being at the end of the header. This is not a restriction; the address can be at other locations. The address is shown to have the value 55.

For brevity, the existence of possible hop count bits in the header is omitted from FIG. 5.

Device 202 extracts 55 from the header. It goes to step Ask 504. It looks in its memory to see if it has the pair (55, [some value]). If so, then the step ‘yes’ is taken and Device 202 assigns Local 506 to that value, shown here as “http://37.47.57.67/”.

But if Device 202 does not have the pair (55, [some value]), then step ‘no’ is taken. Device 202 sends Audio Server 207 the value ‘55’ in a query. Audio Server 207 consults its internal table AST 505 and returns to Device 202 the result “http://37.47.57.67/”. This reply message might include the ‘55’ which Device 202 sent to Audio Server 207, and it might have various other parameters.

Upon getting the reply, Device 202 makes and stores Remote 507, which is (55, http://37.47.57.67), in its permanent memory. Along with an optional timestamp of when this was gotten from Audio Server 207. (The storing in Device 202's permanent memory means that a future detecting of a chirp with a 55 index will cause a local value in memory to be used, saving the cost of the remote call.)

Device 202 appends the body of Shortcode 503 to the appropriate Local 506 or Remote 507 and obtains Make 508. It then makes a remote query (not shown in FIG. 5) to the URL in Make 508.

One nuance to the previous step is that the body of the shortcode is likely to be binary. But for an URL, the contents are usually restricted to ASCII or some supersets of ASCII. So a step can be inserted, where the body of the shortcode is put into a program that maps it into valid URL characters.

Hence it can be seen that the only remote operation in FIG. 5 is the branch to AST 505. Where ‘remote’ means relative to Device 202. Because the entries in the table on Audio Server 207 are likely to be stable over several days or weeks, the advantage is that Device 202 can usually avoid asking Audio Server 207 to decode the chirps it gets.

Another advantage is that this section reduces the bandwidth and computational load on Audio Server 207. It also reduces the size of the hashtable on that machine. The entries in it would be for organisations that are not in the table.

There could be logic on Device 202 that periodically pulls the table or subsets of it, or changes to it, from Audio Server 207. Or, if Device 202 allows this, Audio Server 207 might periodically push those to Device 202 when the latter is turned on and accessible over a wireless network. For some devices, the pull might occur, while for others, the push might occur. Also, if a given device uses pulls, there could be an enabling of Audio Server 207 to supplement this with pushes.

We expand on the remark in the previous paragraph about pulling subsets of the AST from Audio Server 207. How are these subsets determined? One way is from logic on Device 202 that records what websites Jane visits over a period of time. This could be enhanced by recording which of those she made a purchase from, using the device. Also, if the device has location information about itself, it can summarise this and send it to Audio Server 207, which then searches for any stores or audio transmitters owned by entities who have entries in its AST, and where those stores or transmitters are near the locations visited by Jane.

Another way is for Device 202 to use data from another of Jane's computers, like a desktop machine that she often works at, at her home or workplace, for example. This machine might also record which websites Jane visits or buys from. It might send this list to Device 202 via some wired or wireless means, and Device 202 could then ask Audio Server 207. Or the desktop machine might directly ask Audio Server 207 for any associated AST entries, and upon getting these, it could transmit them to Device 202.

Another way is by recommendations from friends of Jane about chirps from companies that they have recorded. There could be cooperative software on her device and her friends' devices that lets her download those AST entries from them.

Bergel states briefly that “hash codes may be index values to the table of a predetermined length”. But these “hash codes” are in the body of the shortcode, not the header. Also, there is no mechanism in Bergel to distinguish when a “hash code” is actually an index and when it is a true hash. Thus Bergel requires a remote lookup of an audio server.

This section described the use of FIG. 5 in the context of FIG. 2, where Device 202 gets a chirp from a screen. But FIG. 5 has broader scope. It is not restricted to the feedback loop and device controlling of FIG. 2. It can be used where there is no such feedback.

Also, FIG. 5 can be used in the context of the feedback loop of FIG. 4, where the mobile Device 402 emits a chirp to Screen 403. The local steps in FIG. 5 can now occur inside Controller 405. The intent is to minimise the number of calls that Controller 405 makes to Audio Server 407, as this will speed up the updating of the images on Screen 403.

Another extension of FIG. 5 is to observe that the only parts of it specific to audio are Microphone 501 and Chirp 502. Suppose there is a barcode encoding that uses the concept of a header and body. This might be a modification of an existing barcode standard or an entirely new standard. Then the method of this section can be applied to the barcode, where FIG. 5 is used in tandem with FIG. 2.

The terminology above of an “Audio” Server Table would not be literally true in this instance. But the idea of factoring out the front portion of an URL into a related type of table can be used. The portion that is factored out can be expected to recur across several barcodes in a given region like a city.

Note however one difference between a barcode and an audio signal. The latter can be expected to be mostly inherently local, because when it exists it can only travel a limited distance while remaining detectable. But if a barcode is instantiated as hardcopy, like on a page in a magazine, then the barcode can travel anywhere. The analog of this for an audio signal was mentioned earlier, where a chirp might be emailed to a user who plays it as a different location from where the chirp was originally recorded. Thus if a barcode were to be used with an AST, it might be best done when the barcode exists mainly or only on an electronic screen, where the visibility of this screen imposes an effective locality restriction on the use of the barcode.

It might be objected that a barcode can have more encoding capacity than an audio signal, so why use an AST to reduce the size of the data inside the barcode? But reducing the size of the data in the barcode has the advantage of increasing the size of the geometric subsets of the barcode, like the squares and rectangles of the QR or Data Matrix methods. Thus the barcode can be more easily detected by a user with a mobile device that has a camera. The tradeoff is that now the decoding steps cannot be entirely done in the mobile device, because there is occasionally a remote call to the audio server to query AST 505.

Suppose the mobile device has a blacklist or whitelist. It can efficiently query the audio server with one or both of the lists. Hence the mobile device can map its blacklist to a list of undesired index values, which it can hold in its memory. Likewise it can map its whitelist to a list of desired index values, also to be held in its memory. The biggest payoff is likely when it can apply the undesired index list against the index value in a shortcode header. It avoids entirely a remote call to an AST.

4.3 Protocol;

This section uses the expectation that much of the data to be converted into shortcodes will be URLs, and that in turn most of the URLs will use http.

One implementation is to allocate one bit in the header. When the bit is set, the data is an URL and starts with “http://”. Then, the data encoded in the body is the rest of the URL. When the bit is not set, the data is another case. That is, the data is not an URL or the data is an URL that does not start with the previous string.

The information saving can be considerable. The length of “http://”' is 7 characters which is, if each character is encoded in a byte, 56 bits in the body. This is replaced by 1 bit in the header. To compute the average saving requires the knowledge of the average fraction of data that will be that URL. This is unknown, and even when known for a given data corpus, might change over time. But empirically, it can be a reasonable observation that the rise of the Web is due to hyperlinks. And that the most common form of this is “http://”.

A variant on the above is to allocate 2 bits in the header. The value is 1 for “http://” and the value is 2 for “https://”. This derives from the observation that the latter protocol is the second most common on the Web. The value can be 3 for a choice of another protocol (perhaps “ftp://”). The value is 0 for all other cases.

Another variant is to allocate enough bits in the header to define cases for all known protocols. This is not recommended. The actual usages of many protocols are and can be expected to be low. Allocating the bits to cover these cases is wasteful of the header space.

Note that the above choices of protocols all assume the default ports for those protocols. Like port 80 for “http://”. If one of those protocols was to use a non-default port, then the setting in the bit/s would be 0 and the entire URL would be encoded in the body.

This section can be combined with the AST section. The steps in the latter can be done first, for companies that have signed up with the audio server to have an index in the AST. In this case, the bit/s in the header for the protocol would be unused. They could be set to 0. The decoding would check the AST bits in the header.

A company who does not have an index in the AST would have the AST bits set to 0. Then, if the company has an URL starting with “http://”, the protocol bit/s would be set to 1.

5. No Screen;

Consider a device Alpha with no screen, but with an

Internet address. As devices are built that can have an Internet address, this is sometimes called a trend of the “Internet of Things”. For cost minimisation, a screen is omitted. So no barcode can be shown. In Bergel, the section “Hardware (Chirp on Chip)” suggests that Alpha can have a microphone that receives a chirp that encodes control instructions. This can be problematic. First, how does a nearby user know what instructions to send to a particular device? This includes both the format of those instructions, as well as the particular values of various parameters. Second, the mechanism is an open loop. There is no ability for the user to get data from Alpha. Instructions to Alpha might first depend on the user reviewing such data. Third, there may be devices that collect data and make these available to any nearby user, where the user can only send read-only instructions, which are limited to just selecting the display of the data.

Another section of Bergel refers to a peer to peer interaction between 2 devices, where they both can emit and receive chirps. This might be combined with the previous paragraph to enable a closed loop interaction between the user's device and Alpha. But this can be awkward. It would involve each outgoing message being first sent to an Audio Server, which makes and returns a shortcode. Then the emitting device converts this to a chirp and emits it. Likewise the receiving device sends the shortcode to the Audio Server to get the original message.

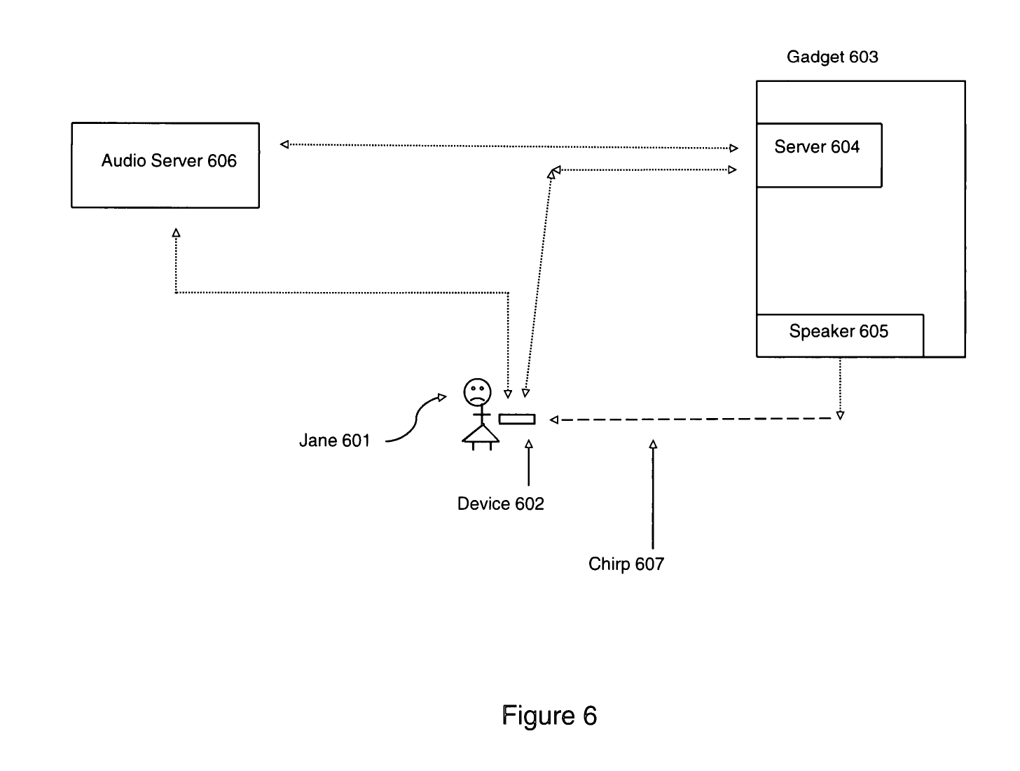

We suggest a simpler alternative in FIG. 6. It shows Jane 601 with her mobile Device 602. She is near Gadget 603. Gadget 603 has 2 components relevant to the interaction. It has a web Server 604 and a Speaker 605. In general, Gadget 603 will have a central processing unit. Plus it might have sensors that aggregate data. These are not explicitly shown in the figure.

Again, perhaps to reduce costs, access is only through the Internet. Assume that Gadget 603 has been installed in a location with Internet access, and that it has been initialised with a valid Internet address. Initially, Gadget 603 makes an URL that refers to its Internet address. Server 604 listens on its Internet connection and will respond to this URL. Gadget 603 sends the URL to Audio Server 606, which returns the shortcode. Speaker 605 plays this as Chirp 607.

Optionally, Gadget 603 might have a button that Jane can press to play the audio. In part, this acts to reduce the energy expenditure of playing the audio. The use of this button depends on whether Jane can physically touch the device or not. Or Gadget 603 might have some sensor that can detect an action by Jane, and translate this into playing the audio.

Device 602 gets Chirp 607 and decodes it to a shortcode and sends it to Audio Server 606 to get the URL. Device 602 then uses the URL to make a connection to Server 604. Server 604 returns a web page. This can have data that Device 602 displays to Jane. The page can have links to other pages from Server 604. Any or several of these pages can have buttons or links that let Jane upload control instructions to Gadget 603, where these can affect the workings of the device, separate from the mere showing of web pages.

Thus we have a closed loop of interaction between Jane and Gadget 603. Also, the only interactions with Audio Server 606 are initially. When Gadget 603 registers its “home page” URL and when Jane's Device 602 sends a shortcode to get that URL. The subsequent interactions between Device 602 and Gadget 603 can be expected to be faster, without the repeated queries to Audio Server 606. Note that Audio Server 606 is meant to be a well known address on the Internet. In one limit, there is only one Audio Server 606 on the globe. More realistically, even if say it distributes requests to local audio servers, none of these might be close to Jane. Whereas given Gadget 603's Internet address and the Internet address of Device 602, it can be expected that the routing between these will be efficiently done, via short connections. Both those Internet addresses should be associated with locations within the same city, if they have been optimally allocated.

There is no ambiguity about what Gadget 603 is and its precise model or make. (At least if the home page and other pages give this information.) This avoids the earlier mentioned problem with the alternative, where Jane has to somehow decide what controls to send to the device.

There is another saving. The default can be that Gadget 603 only makes its registering of its home page with Audio Server 606 once, independent of any later instances of users approaching with their mobile devices. This can be true if the home page URL never changes, once Gadget 603 has been initialised with an Internet address. Hence in a given set of interactions between Jane and Gadget 603, there is effectively only one query to Audio Server 606.

This idea of Gadget 603 emitting a chirp does not exclude the possibility that another device can access Gadget 603's web server by other means. For example, another device might be physically present on the same wired subnet as Gadget 603 (assuming that Gadget 603 is on a wired subnet). The former device might scan the subnet to find Gadget 603. The former device could be run by the system administrator. Whereas Jane's Device 602 might arise in the context of Jane being some arbitrary stranger, and it is not advisable to let her device have wired access to the subset, to scan the subnet. So her device only has wireless access, via her phone provider or a wireless server like a WiFi server.

The above was for Jane manually going through the web pages from Gadget 603 and making manually any control instructions. Or her Device 602 might run a program that treats Server 604 as providing a Web Service. The interaction between Device 602 and Gadget 603 could be fully automated in some usages.

Gadget 603 was assumed to have no screen. In some implementations it might have a projection screen. For example, in our submission “5”, we described a projector phone interacting wirelessly with one or more nearby cellphones. A projector phone is a cellphone with a projector lens that can project images onto an external surface. In the current submission, the interaction between cellphones could be initiated via a chirp. The projector phone might function as a web server. It defines an URL pointing to itself and uses an audio server to get a shortcode. It emits the shortcode as a chirp. A nearby cellphone can decode the chirp and get the web page pointed to by the URL. Hence the cellphone can control what appears on the projection.

6. Multiple Devices;

A configuration is possible of 2 or more devices that are connected to each other, communicating with 1 or more devices by a combination of barcodes and chirps. For example, consider a Cellphone 1 connected to another mobile Device 2, like a laptop or notebook or electronic book reader. This connection could be wired or wireless. The interaction might be bidirectional or omnidirectional. The duo might be owned by one person, Jane, who uses it to interact with one other device, Bob's Cellphone 3.

One interaction is where Cellphone 3 has a camera, which is used to scan a barcode shown on the screen of Cellphone 1 or on the screen of Device 2. Here, data flows to Cellphone 3. For data flow in the other direction, Cellphone 3 emits chirps, which are decoded by Cellphone 1.

Note that the emitting of chirps by Cellphone 3 gets around a limitation where no chirps are used, where instead Cellphone 3 shows a barcode on its screen, to be read by the other devices. This might not be possible or be very awkward due to the geometry of Cellphone 3 and the geometry of the other devices. For example, if the camera of Cellphone 3 is on a different side of the phone than the screen. Whereas the non-line of sight property of the chirp gives more flexibility to the relative positioning of all the devices.

Another interaction is where Cellphone 3 shows a barcode on its screen, which is imaged by one of Cellphone 1 or Device 2. While in turn, one of those latter devices emits a chirp, which is decoded by Cellphone 3.

Now consider 2 devices interacting with 2 devices. We have Cellphone 1 and Device 2, as earlier. There is now Cellphone 3 and Device 4 in a wired or wireless connection. Note that the interaction between Cellphone 1 and Device 2 need not be the same as that between Cellphone 3 and Device 4.

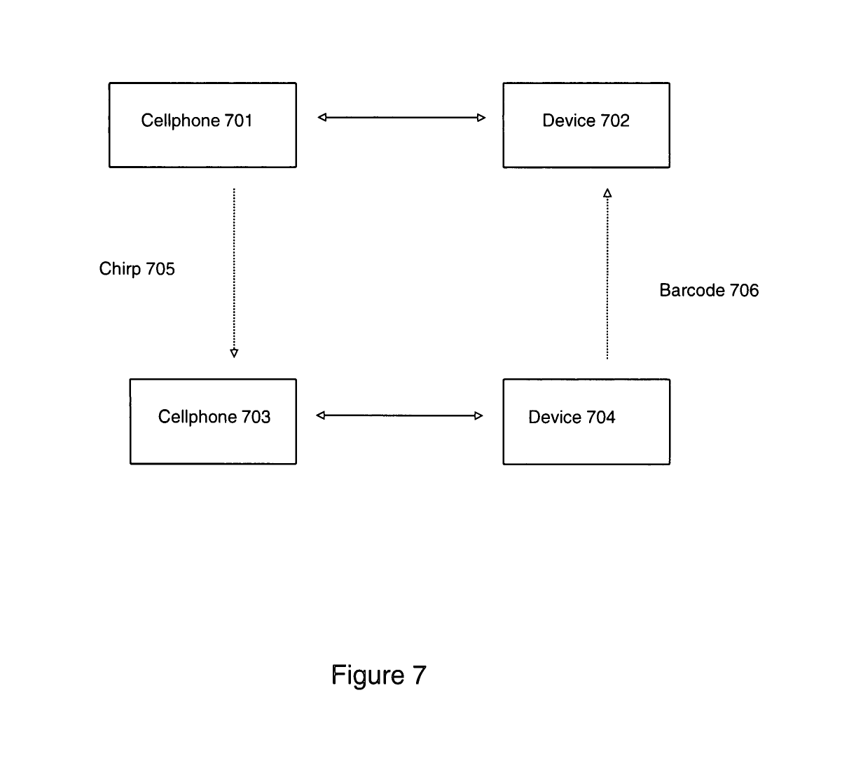

One interaction between the 2 pairs is for Cellphone 1 to emit chirps which are decoded by Cellphone 3. While Device 4 shows barcodes that are decoded by Device 2, assuming that the latter has a camera and suitable software. This is shown in FIG. 7, where Cellphone 1 is mapped to Cellphone 701, Device 2 is mapped to Device 702, Cellphone 3 is mapped to Cellphone 703, Device 4 is mapped to Device 704. And Chirp 705 is sent from Cellphone 701 to Cellphone 703, while Barcode 706 is produced on Device 704 and scanned by Device 702. If Device 704 has a larger screen than Cellphone 703 (e.g. if Device 704 is a laptop or ebook reader), then the display of Barcode 706 on Device 704's screen can be larger than if it was shown on Cellphone 703's screen. Hence it could be easier for Device 702's camera to focus on Barcode 706.

Another interaction is for Cellphone 1 to emit chirps which are decoded by Device 4, assuming it has a microphone and suitable software. While Cellphone 3 emits chirps that are decoded by one of Cellphone 1 or Device 2. If Device 2 is to decode chirps, this assumes it has a microphone and suitable software.

The previous interaction is entirely via chirps. This also assumes that there is no or little interference between the chirps, if they overlap in time. This might be achieved via the chirps being in different frequency bands. Or the interaction might involve the chirps being broadcast in alternating manner. Or, as found by Bergel, the audio analysis software that decodes the recorded audio can distinguish between 2 simultaneous signals, if it uses knowledge of the audio output coming from its partner device.

For a combination of 3 or more devices connected to each other that interact with 2 or more devices connected to each other, many of the interactions would be obvious elaborations of the above.

7. Audio Server Actions;

Consider what the audio server can do with the requests it gets from devices, both to convert an URL into a shortcode and the inverse. The latter requests are expected to be (far?) more frequent than the former. They come from users' mobile devices that are trying to decode received chirps. The audio server can compute statistics on various properties. One would be the temporal and spatial distribution of the requests. The temporal data comes from the audio server's internal clock. The spatial data can come from mapping the addresses of the requesting devices to locations. Though as explained earlier, this might be approximate, if the devices are using the phone carrier network, and the latter's Internet addresses are mapped to the offices of the phone carrier. Where this assumes the mobile devices are not directly giving their locations to the audio server.

The audio server can also correlate any spatial data from the decoding queries to any knowledge it has of the locations of the chirp transmitters. The companies that ask for the encoding might tell the audio server these locations. Note that this includes the case where the transmitters are mobile, like the moving electronic billboards.

What is also useful is if a chirp request comes from a location different from those requests for the same chirp. If the chirp is known to be spatially localized (e.g. from a fixed transmitter), the external request could indicate a lengthy rebroadcast, or a user getting the chirp via an electronic message that wrapped a recording of the chirp.

Suppose a user is on a social network, with a group of ‘friends’, as defined by that network. If the audio server has access to the friends of a requester, it can use this to study the collective behavior of the group visa vis their use of chirps. For example, a user could ask the audio server for where and when her friends typically get chirps. Also, she could ask who emits the chirps. For the locations of those chirps, she might ask more specifically for locations where there are screens controllable by the chirps.

The owners of the screens (or the advertisers on those screens) broadcasting chirps could associate keywords with the screens. These could be uploaded to the audio server. Where perhaps a keyword has a time dependence, as well as a spatial dependence. The former might be because the owner or advertiser will at certain times have certain ads or visual material about the keyword. The audio server can offer search ability to users, based on the keywords. It could charge the owners or advertisers for this service.

Separately, the audio server could spider an URL that it gets in a request to make a shortcode from the URL. The request might be presumed to come from a web server controlling a screen or device that will emit the chirp to be made from the shortcode. The spidering should be done in observance of any “no robot” (or related) permissions or files commonly used by websites to control the automated spidering of their sites by, amongst others, search engines. If the site gives permission, a caveat needs to be added, when the URL is meant to be used by a mobile device to control a screen. If the audio server spiders the web page pointed to by the URL, this should not be interpreted by the website as a request to control the screen implicitly referred to inside the syntax of the URL.

This can be handled as follows. In general, the web server knows the address of the audio server. And there is expected to be only a few such audio servers. In the limit, only one, where this is the audio server for the city in which the web server has a screen that emits chirps. So the web server can regard any query with the URL coming from a few known audio server addresses as a special case. It will not alter the screen.

Also, recall that the URL in general will result in a web page of controls downloaded to a mobile device, and a corresponding page or image on the emitter screen. In general, what the web server sends to the emitter screen does not have to be a web page. It can just be an image. The web server can assist the audio server. It can provide both the control web page and the screen image to the audio server.

Plus, consider when the audio server spiders down into the links on the control web page; mimicking what a user might manually do in front of the screen. The web server would act similarly to the previous paragraph.

Note that especially if the data sent to the emitter screen is pure images, then the web server might associate numerous keywords with the images. So that these can be searchable; more easily than images.

So the results returned from the web server to the audio server could consist of paired data—the control web page and the associated image or HTML screen web page, plus any affiliated keywords. One implementation might be to wrap the pair in XML tags, e.g.

<result>

<control>

<!——control web page goes here——>

</control>

<bigPage>

<!——image or page on the big screen goes here——>

</bigPage>

</result>

In the pairing, it is possible that in specific cases a given control web page maps to several image pages. For example, where the user interface was designed so that the controls look the same when the user is scrolling through a set of images or video on the big screen.

It is also possible, though perhaps more unlikely, that a given image page is associated with different control pages.

A variant on the above is where the audio server has a different procedure for a web server submitting an URL, as opposed to an end user doing so. The audio server could run a Web Server that takes an input of an URL. Along with the associated page or image that would appear on the big screen. This pre-empting could be more efficient than the spidering by the audio server.

The preceding remarks in this section were for an audio server spidering a web server controlling a screen emitting a chirp. The remarks could also apply to the web server handling spidering requests from a general purpose search engine in a similar way. Here, the website could have the addresses of those search engines, from which spiders are sent.

There is a caveat. The audio server inherently has a starting point when spidering the web server, because it gets the URLs from the web server. A search engine will not have these starting points. Instead of this being an instance of the “deep web” (“hidden” web pages unspiderable to the search engine), the web server can act to assist the search engine. The web server can in a programmatic fashion make available the URLs as starting points. This could be achieved via XML encodings, as a Web Service accessible to the search engines, where the meaning of the XML tags is published by the web server. Or, more efficiently, a standard set of tags is published by an industry standards body and used by the web server and search engines.

We claim:

1. A system of a website making a Universal Resource Locator (“URL”) with the address of the website and with an identifier of an electronic screen (“Kappa”); where the website controls Kappa; the website sending the URL to an audio server; the audio server associating the URL with a bit string (“shortcode”) in a table (“T”); the audio server sending the shortcode to the website; the website sending the shortcode to Kappa; Kappa emitting the shortcode as audio (“chirp”) via a speaker; where a mobile device detects the chirp and extracts the shortcode; where the mobile device queries the audio server with the shortcode; where the audio server returns the URL (“Chi”);
where the mobile device makes a browser query with Chi; where the website sends a web page to the mobile device; where the website optionally alters Kappa; where selectable items in the mobile device web page cause the website to alter Kappa.

2. The system of claim 1, where, when the mobile device queries the audio server, the audio server makes a query with Chi to the website; where the audio server writes the return address in the query to be the Internet address of the mobile device.

3. The system of claim 1, where Kappa shows a barcode, in addition to emitting a chirp; where the barcode encodes an URL (“Phi”) referring to the same website as the chirp.

4. The system of claim 3, where the Chi web page has selectable items that cause the website to not show or show a barcode on Kappa; where the Chi web page has selectable items that cause the Kappa speaker to emit or not emit chirps.

5. The system of claim 3, where the Phi web page has selectable items that cause the website to not show or show a barcode on Kappa; where the Phi web page has selectable items that cause the Kappa speaker to emit or not emit future chirps.

6. The system of claim 1, where Kappa has a left speaker and a right speaker; where the left speaker emits a different chirp than the right speaker; where the chirps encode different URLs; where the mobile device makes a browser query with a decoded URL; where the website allocates a left subset of Kappa to the control of the mobile device if the URL corresponds to the chirp from the left speaker; where the website allocates a right subset of Kappa to the control of the mobile device if the URL corresponds to the chirp from the right speaker.

7. The system of claim 1, where the website uploads an expiration date, associated with the URL, to the audio server; where the audio server stores the expiration date with the URL in T; where the audio server periodically checks T for expired entries; where an expired entry is moved to an Expired table; where if the audio server gets from a device a query with a shortcode and there is no entry in T, the audio server checks the Expired table; where if a shortcode is present in the Expired table, the audio server sends the URL to the website, with the return address set to the address of the device.

8. The system of claim 7, where if the website gets an URL after the expiration date, the website does not alter the image on Kappa; where the website sends a web page to the device, indicating that the device cannot control Kappa.

9. The system of claim 1, where the mobile device uploads a blacklist of undesired addresses to the audio server; where when the mobile device uploads a shortcode to the audio server, the audio server obtains the corresponding URL; where if the address in the URL is in the blacklist, the audio server returns an error page to the mobile device.

10. The system of claim 1, where the audio server spiders the website with an URL originally sent to it by the website; where the website detects the request as coming from a known address of the audio server; where the website returns the web page made for the mobile device and the image or page made for Kappa.

11. A system of a mobile device contacting a website; the website making an URL with the address of the website and with an identification of the address of the mobile device; the website sending the URL to an audio server; the audio server associating the URL with a shortcode; the audio server sending the shortcode to the website; the website sending the shortcode and a web page to the mobile device; the mobile device emitting the shortcode as a chirp; an electronic screen having a microphone; the electronic screen decoding the chirp into a shortcode; the electronic screen sending the shortcode to the audio server; the audio server replying with the URL; the electronic screen making a query to the URL; the website sending a web page to the electronic screen; the mobile device web page having items that can alter the electronic screen web page.

12. The system of claim 11, where the audio server gets the shortcode from the electronic screen; where the audio server sends the associated URL in a query to the website;
where the return address is the address of the electronic screen.

13. A system of a shortcode having a structure of a header and a body; where a subset of bits in the header defines an “index”; where a device detects the shortcode; where the device checks its memory for an association of the index with an URL prefix; where if the prefix exists the device appends the shortcode body to the prefix and makes an URL; where the device makes a query to the URL; where if the prefix does not exist, the device queries a server with the index; where the server returns an URL prefix; where the device stores the association of the index with the prefix; where the device appends the shortcode body to the prefix and makes a query to the resultant URL.

14. The system of claim 13, where the server accepts a query of an Internet domain name or corporate name; where the server replies with a set of zero or more pairs of an index and an URL prefix; where the prefixes contain Internet addresses or domains owned by the organisation.

15. The system of claim 13, where the server accepts a query of a location; where the server replies with a set of zero or more pairs of an index and an URL prefix; where the data is for companies that own the URLs, and which have chirp emitters in a region around the location.

16. The system of claim 15, where the region is a circle, where the query includes a radius of the circle.

17. The system of claim 13, where a different subset of the header defines a “hop count” non-negative integer; where a chirp made from the shortcode is detected and decoded by a device; where if the hop count is greater than zero, the device decrements it and makes a new chirp from the altered shortcode, and where the device emits the chirp.

18. A system of a website (“Gamma”) making an URL referring to itself; where Gamma sends the URL to an audio server; where the audio server stores an association between a shortcode and the URL; where the audio server returns the shortcode; where Gamma makes a chirp from the shortcode; where Gamma emits the chirp; where a mobile device (“Phi”) records the chirp and extracts the shortcode; where Phi queries the audio server with the shortcode; where the audio server returns the URL;
where Phi makes a query with the URL; where Gamma replies with a web page; where the page shows data from Gamma and selectable items that control Gamma.

19. The system of claim 18, where Phi makes changes to the web page and returns the page to Gamma; where the changes cause a different chirp to be emitted by Gamma.

20. The system of claim 18, where Gamma is a projector phone; where a nearby mobile device records the chirp emitted by Gamma; where the mobile device gets a web page from Gamma; where the mobile device uses the web page to control the contents shown on the projection surface.
